(19) United States
(12) Patent Application Publication
(10) Pub. No.: US 2010/0243822 A1
(43) Pub. Date: Sep. 30, 2010

(54) POWER SUPPLY CABLE OUTLET ANGLE ADJUSTMENT STRUCTURE

(75) Inventor: Andreas Bertram Christoph Nandzik, Glinde (DE)

Correspondence Address: Ching-Ling Huang, 5597 NW 127th Ter, Portland, OR, 97229, US

(73) Assignees: LISTAN ASIA INC., Taoyuan County (TW); LISTAN GMBH & CO. KG, Glinde (DE)

(21) Appl. No.: 12/410,471

(22) Filed: Mar. 25, 2009

(51) Int. Cl. F16L 3/015

(52) U.S. Cl. 248/56

(57) ABSTRACT

A power supply cable outlet angle adjustment structure aims to overcome shortcomings of the conventional power supply that cannot adjust cable outlet angle to mate connecting electronic devices. The power supply has an opening on a body to allow a power cable to be threaded through and a pivotal turnable adjustment member connected to the opening. The adjustment member has a cable outlet to allow the power cable to be drawn out. The power cable can be pivotally turned synchronously with the adjustment member at a selected outlet angle to mate different installing locations of the electronic devices to facilitate connection between them.

### FIELD OF THE INVENTION

The present invention relates to a power supply cable outlet angle adjustment structure and particularly to a cable outlet angle adjustment structure to adjust cable outlet angles of a power supply.

### BACKGROUND OF THE INVENTION

Advance of technology has made computer an indispensable product in people's life. A computer needs electric power which is mainly drawn from input power (such as city power or AC power) through a power supply. The input power is transformed to output power of varying potential to supply various electronic devices (such as motherboard, CD-ROM drive, hard disk driver, air fan and the like) to meet operation requirements.

A conventional power supply, such as those disclosed in R.O.C. patent Nos. M352076, M312700 and I247980, commonly is installed in a computer host with a power cable drawn out through a power supply back panel and connected to various electronic devices held in the computer host. However, the power cable usually is drawn out in one direction. As the electronic devices are installed at different locations in the computer host, connecting between the power cable and the electronic devices encounters problems, notably:

1. The power cable has to be bent in various directions to fit the electronic devices at different locations for connection. Installation is time-consuming and difficult.

2. Wiring of the power cable in the computer host is cluttered due to the reason previously discussed. This is not appealing and could affect internal airflow and result in poor internal cooling of the computer host.

3. A greater angle could be formed between the cable connecting location of the electronic devices and the power supply cable outlet, and the power cable also has to be bent at a greater angle. This could result in damage of the power cable.

### SUMMARY OF THE INVENTION

The primary object of the present invention is to solve the aforesaid disadvantages by providing a power supply cable outlet angle adjustment structure to adjust cable outlet angle to mate different installing locations of electronic devices.

To achieve the foregoing object, the power supply adopted the invention has an opening on a body thereof to allow a power cable to thread through. The opening is connected with an adjustment member which is pivotal turnable relative to the opening. The adjustment member has a cable outlet allowing the power cable to thread through. Through pivotally turning of the adjustment member, the power cable also can be turned and adjusted at a desired outlet angle synchronously. Compared with the conventional techniques, the present invention can adjust the cable outlet angle of the power supply to suit different mounting locations of electronic devices to facilitate connection between them.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is another exploded view of the invention.

FIGS. 4A and 4B are schematic views of the invention in use condition-1.

FIGS. 5A and 5B are schematic views of the invention in use condition-2.

FIGS. 6A and 6B are schematic views of the invention in use condition-3.

### DETAILED DESCRIPTION OF THE PREFERRED EMBODIMENTS

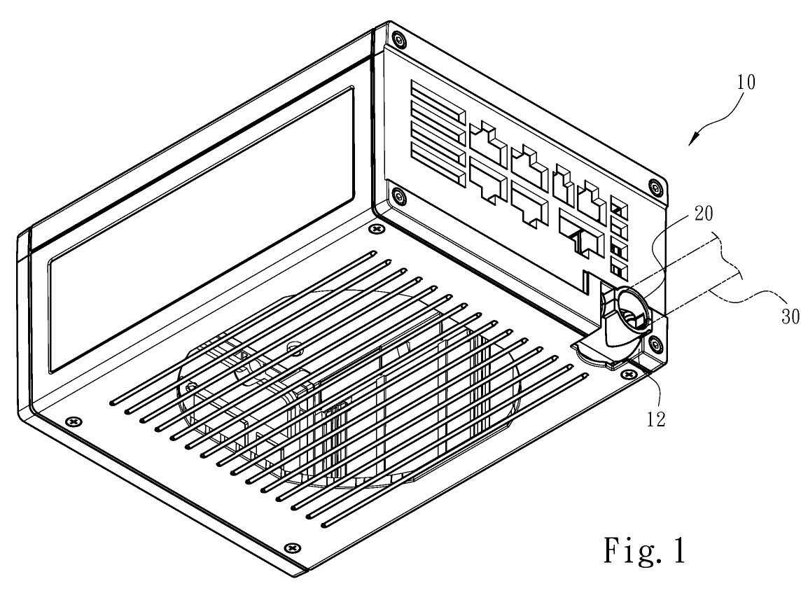

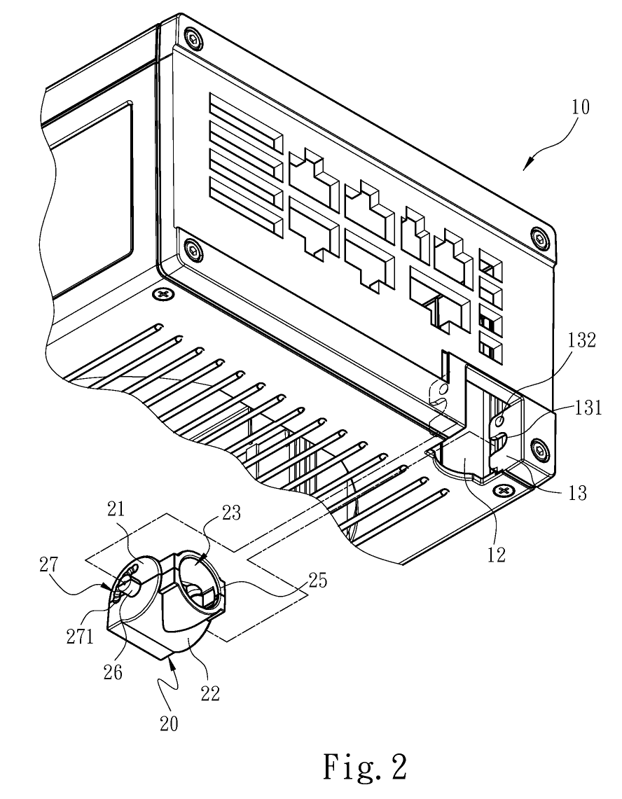

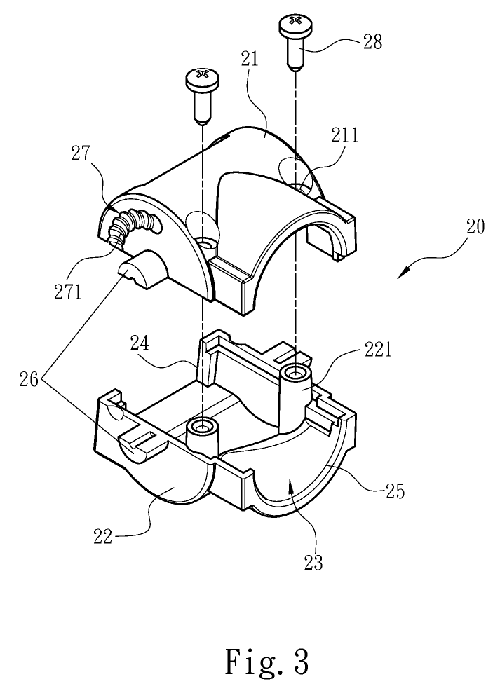

Please refer to FIGS. 1, 2 and 3, the power supply cable outlet angle adjustment structure according to the invention aims to be installed on a power supply 10 which has a body on which an opening 12 is formed to serve as an outlet of a power cable 30. The opening 12 includes a through hole with at least two abutting end surfaces. The opening 12 is connected with an adjustment member 20 which is pivotal turnable. The power supply 10 further has a holding portion 13 extended inwards in the opening 12 to hold the adjustment member 20. The adjustment member 20 and the holding portion 13 have respectively a first coupling portion 26 and a second coupling portion 131 to form the pivotal turnable relationship between them. In an embodiment of the invention, the first and second coupling portions 26 and 131 are a pivot and a notch mating each other so that the pivot can be held in the notch to make the adjustment member 20 pivotal turnable relative to the opening 12.

The adjustment member 20 is hollow and has a housing space 23 inside formed with two ends to respectively become a cable inlet 24 and a cable outlet 25. The cable inlet 24 is a square orifice to receive the power cable 30. The cable outlet 25 is a round orifice to allow the power cable 30 to be bundled and threaded outwards. Hence the power cable 30 can also be pivotally turned with the adjustment member 20 at the same time to adjust the cable outlet angle of the power supply 10. In addition, the adjustment member 20 and the holding portion 13 have respectively a first anchor portion 27 and a second anchor portion 132 on the pivotal turning displacement to form an anchor relationship. The first anchor portion 27 and second anchor portion 132 are respectively a slot and a strut latchable with each other. The slot has a plurality of consecutive notches 271 mating the strut. Hence when the adjustment member 20 is pivotally turned, the strut of the second anchor portion 132 can be latched on the notches 271 of the first anchor portion 27 to form multi-stage anchoring at selected angles.

In practice, the adjustment member 20 may be a one piece element. It may also consist of a first half body 21 and a second half body 22 coupling together to form the housing space 23. The first half body 21 and second half body 22 have respectively a first fastening portion 211 and a second fastening portion 221 that are respectively an aperture and a strut mating each other. A fastening element 28 (such as a screw) is provided to run through and fasten the first fastening portion 211 and the second fastening portion 221. For installation, first, dispose the power cable 30 in the housing space 23 between the first half body 21 and the second half body 22; next, couple the first half body 21 and the second half body 22 by fastening the first fastening portion 211 and the second fastening portion 221 through the fastening element 28 to hold the power cable 30 in the housing space 23 and thread through the adjustment member 20; finally, fasten the first coupling portion 26 to the second coupling portion 131, then the adjustment member 20 can be pivotally turned to adjust the power cable 30 at a desired outlet angle and direction.

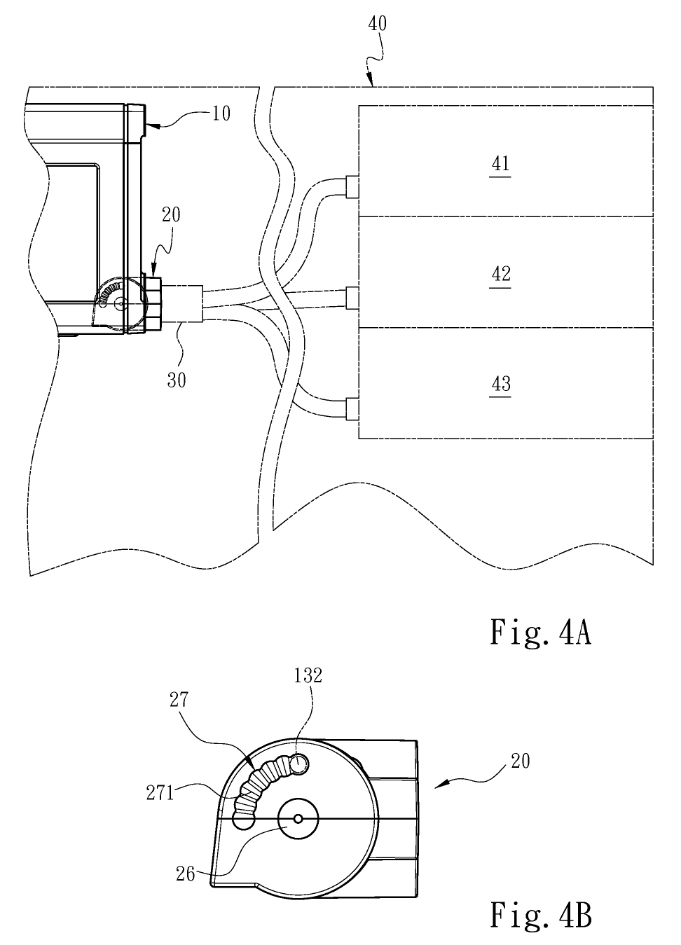

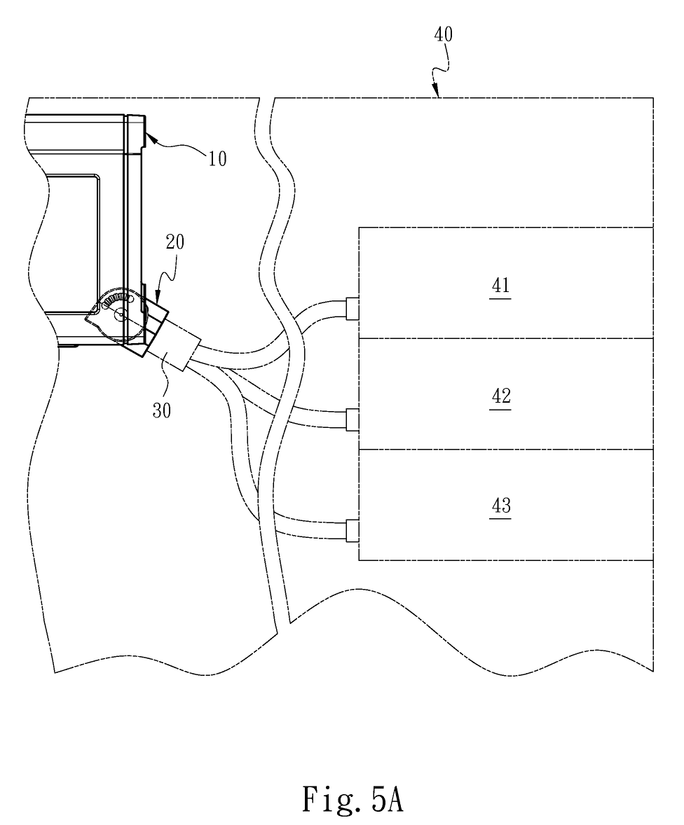

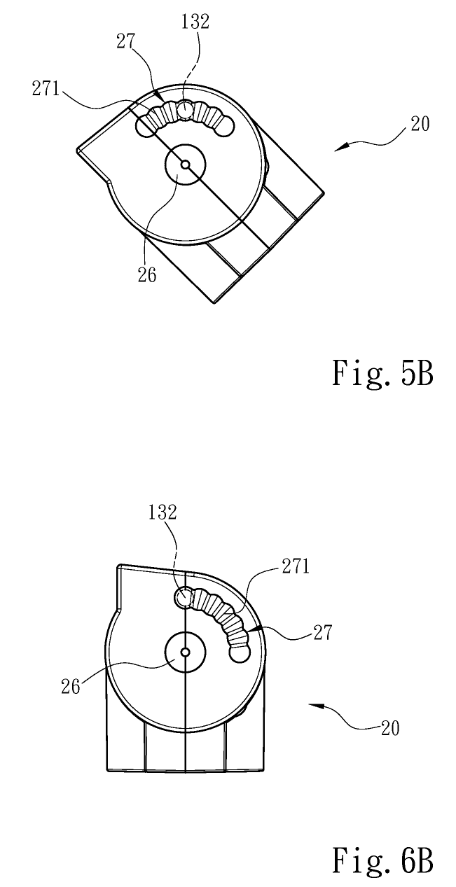

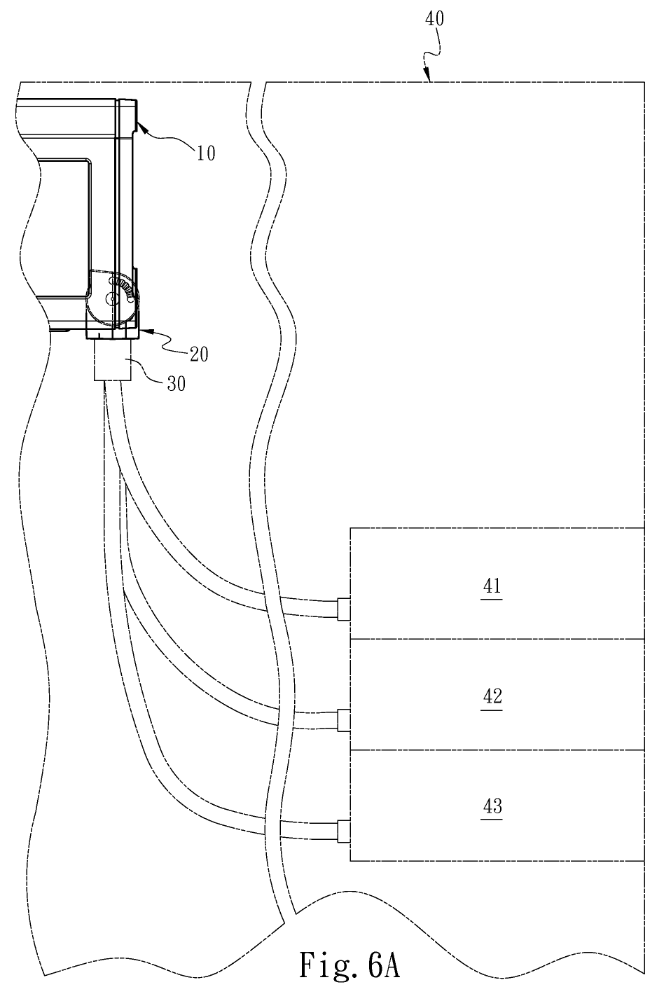

Also referring to FIGS. 4A and 4B, when the power supply 10 is installed on a computer host 40, electronic devices 41, 42 and 43 (such as hard disk drive, CD-ROM drive, CD burner and the like) are mounted on different locations, the power cable of the power supply 10 can be adjusted at different outlet angles to suit their different locations. For instance, in the event that the electronic devices 41, 42 and 43 are installed on higher locations, the adjustment member 20 can be adjusted at a higher outlet angle by latching the second anchor portion 132 on a front end of the notches 271 of the first anchor portion 27 to position the adjustment member 20 in a horizontal manner. Referring to FIGS. 5A and 5B, when the electronic devices 41, 42 and 43 are installed on lower locations, the adjustment member 20 can be pivotally turned to move the second anchor portion 132 away from the front end of the notches 271 and latch on a middle section of the notches 271, so that the adjustment member 20 is positioned at an inclined manner to allow the power cable to be drawn out accordingly. Referring to FIGS. 6A and 6B, in the event that the electronic devices 41, 42 and 43 are installed on even lower locations, the adjustment member 20 can be pivotally turned further to move the second anchor portion 132 away from the middle section of the notches 271 to a rear end of the notches 271, so that the power cable can be threaded out through the adjustment member 20 in a vertical manner. The embodiments previously discussed aim to explain turning angle alterations of the adjustment member 20, and do not limit the angular range. By providing multiple notches 271 of the first anchor portion 27 and the strut of the second anchor portion 132, a multi-stage anchoring can be formed to make power cable outlet angle suitable to various installing locations of the electronic devices 41, 42 and 43.

As a conclusion, the power supply 10 according to the invention has an opening 12 to allow a power cable 30 to be threaded through and an adjustment member 20 pivotally connected on the opening 12 that is pivotal turnable to adjust the power cable 30 concurrently at a desired outlet angle according to different installing locations of electronic devices 41, 42 and 43 in a computer host 40 to be connected. It offers a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply cable outlet angle adjustment structure installed on a power supply which has a body formed with an opening to allow a power cable to be threaded through, comprising:
a pivotal turnable adjustment member which is connected relatively to the opening and has a cable outlet to allow the power cable to be drawn out at a selected outlet angle which is adjustable synchronously with pivotal turning of the adjustment member.

2. The power supply cable outlet angle adjustment structure of claim 1, wherein the opening of the power supply extendedly has a holding portion to hold the adjustment member.

3. The power supply cable outlet angle adjustment structure of claim 2, wherein the adjustment member and the holding portion have respectively a first coupling portion and a second coupling portion to form pivotal turning of the adjustment member.

4. The power supply cable outlet angle adjustment structure of claim 3, wherein the first coupling portion and the second coupling portion are a pivot and a notch mating each other.

5. The power supply cable outlet angle adjustment structure of claim 2, wherein the adjustment member and the holding portion have respectively a first anchor portion and a second anchor portion to form anchoring during pivotal turning of the adjustment member.

6. The power supply cable outlet angle adjustment structure of claim 5, wherein the first anchor portion and the second anchor portion are respectively a slot and a strut latchable with each other.

7. The power supply cable outlet angle adjustment structure of claim 6, wherein the slot has a plurality of notches mating the strut.

8. The power supply cable outlet angle adjustment structure of claim 7, wherein the notches are formed consecutively.

9. The power supply cable outlet angle adjustment structure of claim 1, wherein the adjustment member is formed in one piece.

10. The power supply cable outlet angle adjustment structure of claim 1, wherein the adjustment member includes a first half body and a second half body fastenable to each other to form a housing space to hold the power cable.

11. The power supply cable outlet angle adjustment structure of claim 10, wherein the first half portion and the second half portion have respectively a first fastening portion and a second fastening portion to fasten to each other.

12. The power supply cable outlet angle adjustment structure of claim 11 further having a fastening element running through and fastening the first fastening portion of the first half portion to the second fastening portion of the second half body.

13. The power supply cable outlet angle adjustment structure of claim 11, wherein the first fastening portion and the second fastening portion are respectively an aperture and a strut mating the aperture.

14. The power supply cable outlet angle adjustment structure of claim 10, wherein the adjustment member has respectively a cable inlet and the cable outlet at two ends of the housing space.

15. The power supply cable outlet angle adjustment structure of claim 14, wherein the cable outlet is a round orifice to bundle the power cable.

16. The power supply cable outlet angle adjustment structure of claim 14, wherein the cable inlet is a square orifice to allow the power cable to be threaded through.

17. The power supply cable outlet angle adjustment structure of claim 1, wherein the cable outlet is a round orifice to bundle the power cable.

18. The power supply cable outlet angle adjustment structure of claim 1, wherein the opening is a through hole formed on the power supply and has at least two abutting end surfaces.
